(19) United States
(12) Patent Application Publication
(10) Pub. No.: US 2008/0252470 A1
(43) Pub. Date: Oct. 16, 2008

(54) Leak Detectors and Leak Detection Methods

(76) Inventor: Tari Taricco, Long Beach, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/629,151

(22) PCT Filed: Jun. 24, 2005
(86) PCT No.: PCT/US2005/022322

§ 371 Date: Nov. 27, 2007

Related U.S. Application Data
(60) Provisional application No. 60/582,469, filed on Jun. 24, 2004.

(51) Int. Cl. G08B 21/00

(52) U.S. Cl. 340/605

(57) ABSTRACT

Leak detectors and leak detection methods (20) using a self contained unit having a pressure sensor (15) configured to be connected to an enclosed volume to be maintained at a pressure different from atmospheric pressure, an audible soung generator (18) and a LED (26), the audible soung generator (18) and the LED (26) being responsive to the pressure sensor (15) to emit an audible sound and a visible warning, respectively, when the pressure sensor senses pressure reaching a predetermined limit.

### BACKGROUND OF THE INVENTION

1. Field of the Invention

The present invention relates to the field of composite structure manufacture.

2. Prior Art

In certain activities, it is necessary or desired to maintain a temporary or continuous vacuum or pressure in a system. By way of example, in the manufacture of composite structures, layers of high strength filament in such forms as mats, woven cloth and/or rovings are placed in an open face mold and impregnated with an epoxy or other resin. A flexible member is then placed over the mold and sealed to enclose the impregnated high strength filament structure and then a vacuum is drawn thereon to remove the air and volatile components from the resin saturated assembly prior to curing. The resin is then cured, the mold opened and the part removed. The vacuum may or may not be held on the structure while curing

In the foregoing fabrication process. the required vacuum must be maintained for the required length of time to achieve the desired results. Otherwise, the integrity of the finished part may be compromised, and particularly in critical applications such as in aircraft parts, undetected failure of the vacuum may result in the scrapping of the finished part.

To monitor the vacuum in such processes, in the prior art a vacuum gauge was used to detect the loss of any required level of vacuum to allow an operator to eliminate the leak and restore the vacuum as required. However, this, in turn, requires the attention of an operator, thereby limiting the ability of the operator to tend to other tasks during the process.

The foregoing is merely one example where a vacuum, or alternatively a pressure, must be held for a predetermined period of time for processing, testing or for other purposes.

### BRIEF DESCRIPTION OF THE DRAWINGS

FIG. 1 is a block diagram of one embodiment of the present invention.

FIG. 2 is a perspective view of one embodiment of the present invention.

FIG. 3 is a perspective view of an embodiment of the present invention connected to a vacuum bag of a mold for monitoring the vacuum therein as provided though other connections to the vacuum bag.

FIG. 4 is a block diagram of another embodiment of the present invention.

### DETAILED DESCRIPTION OF THE PREFERRED EMBODIMENTS

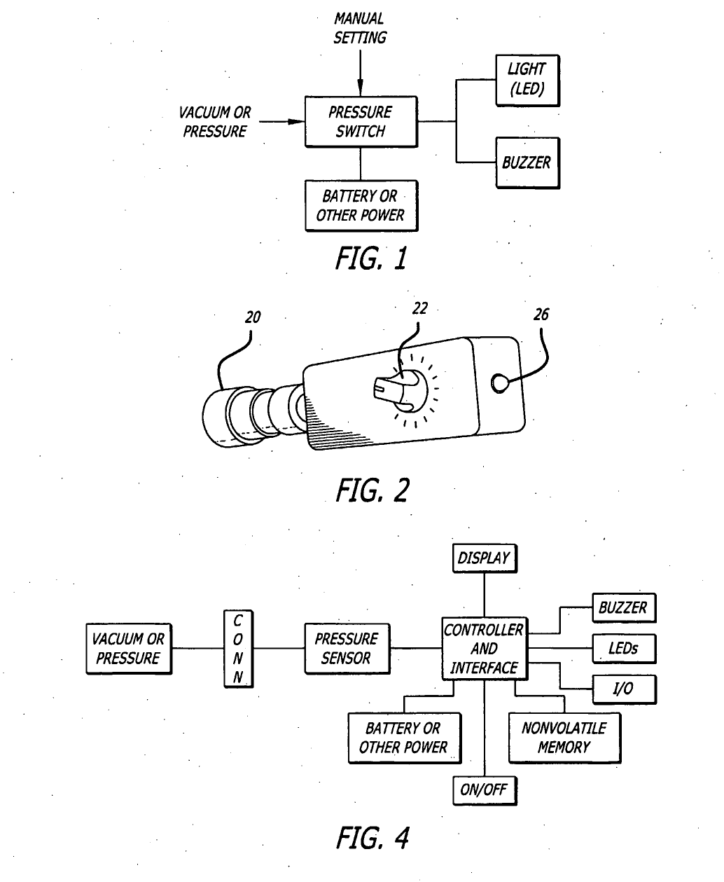

In a preferred embodiment of the present invention method, a vacuum sensing system is provided which may generate both a visual and an audible alarm, allowing an operator to tend to other activities unless or until an alarm is noted, indicating that a mold needs attention. In particular, as shown in FIG. 1, an adjustable pressure switch that may be manually set is coupled to the mold cavity, and preferably after the initial required vacuum level is achieved, is manually set to sense an unacceptable level (loss) of vacuum being achieved or being approached. On closure of the pressure switch, battery or other power is applied to a buzzer and a light, preferably a red LED, on the assembly to alert an operator. In that regard, the buzzer will alert an operator without requiring his visual attention, while the LED, if not first noted, is at least effective in identifying which mold needs attention.

The LEDs and buzzer, when triggered by the pressure switch, may turn on and remain on until the vacuum is restored, or may be intermittent to conserve battery power. In that regard, unless or until triggered, the pressure switch being open prevents any drain of power from the battery or other power source. To prevent triggering when the vacuum is intentionally removed, an on/off switch may be provided, or alternatively, the manual setting for the pressure switch may simply be turned to a position where it won't be triggered by an absence of vacuum.

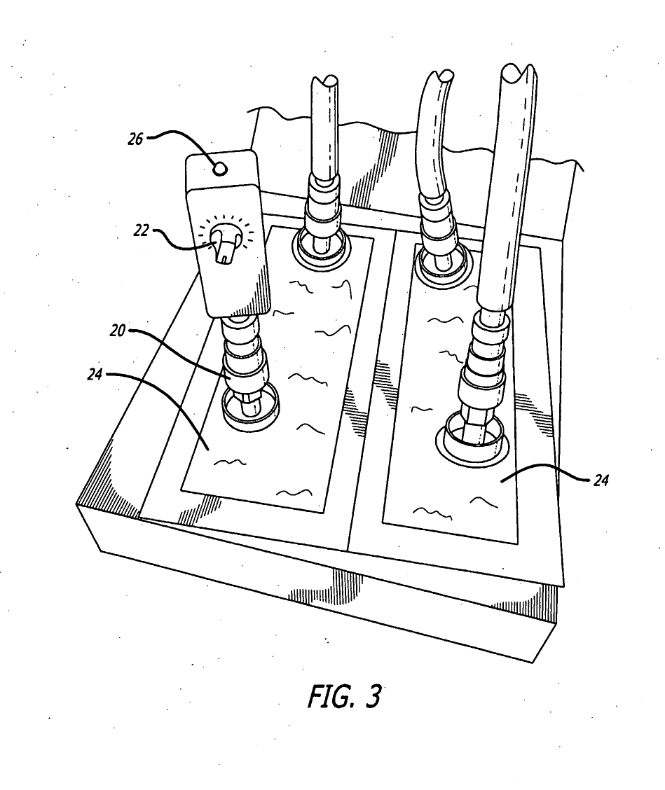

One embodiment of the device in accordance with the present invention as just described may be seen in FIG. 2. The device has a quick disconnect vacuum connection 20, though other types of connections could be used if desired. The knob 22 for the manual setting of the vacuum level is clearly visible in the Figure, the LED not being visible in this Figure and the buzzer, being mounted internally, also not being visible. FIG. 3 shows a device in accordance with FIGS. 1 and 2 as mounted on the flexible member 24 sealing a mold cavity, the LED 26 being visible at the top of the device in these Figures.

In other activities, it may be necessary to temporarily hold a pressure on a system, such as for a manufacturing or test purpose. Again referring to the fabrication of composite materials, sometimes a vacuum is drawn on the resin soaked high strength filament to expand the air pockets and air bubbles to remove the same to the maximum extent reasonably possible, and then pressure is applied to collapse any remaining small bubbles for curing purposes. Here, loss of pressure before or during curing may compromise the quality of the end product, and in critical applications, require the same to be scrapped. Accordingly, embodiments of the present invention in accordance with FIG. 1 adapted to sense the drop in pressure to below a given level could easily draw an operator's attention to the impending loss of pressure, allowing corrective action to be taken before unfortunate results occur.

In other applications, it may be necessary to leave a pressure (or vacuum) on a system for a prolonged period without loss of pressure or vacuum as a leak test of the same. In such applications, as with any other application, the present invention might be used together with a pressure gauge, separate or integral with the disclosed device. In this application, the pressure gauge would confirm that the pressure or vacuum remained within acceptable limits throughout the prolonged period, with the adjustable pressure of vacuum switch detecting a more rapid leak so that the leak may be more immediately found and fixed and the system reset, hopefully now to properly perform throughout the more prolonged test period.

Alternatively, the pressure switch may be replaced by a pressure transducer, either analog or digital. Also a microprocessor may be used to interface all components and thus provide additional functions such as external calibration and communications, calibration, power management, remote setting, data storage, and to make data based decisions implemented in software. Such an embodiment is shown in FIG. 4. This embodiment uses a pressure transducer to provide an input to a controller and interface. The pressure transducer, preferably having a proportional output, may be an absolute pressure transducer, though a gauge pressure transducer is preferred as providing a pressure reading referenced to atmospheric pressure. The pressure transducer is connected to a vacuum or pressure that is to be maintained through a connector CONN, which as a matter of convenience may be a quick disconnect connector in accordance with the previous embodiments. The controller and interface preferably will be a low power CMOS processor operating on battery power, though alternately or in addition, a provision may be made to operate using some other power source. The controller and interface normally will be controlled through the I/O connection to a personal computer or other device, such as a hand-held device, that may be used to control the controller and interface and to read the data stored in memory. In that regard, in the preferred embodiment the controller and interface is provided or includes non-volatile memory such as EEPROM or flash memory to retain data taken prior to loss of power either by turning the ON/OFF switch or by loss of power at its source (such as a dead battery). Alternatively of course, data could be stored in random access memory, though with a risk of inadvertent loss. As a further alternative, the device of the present invention may be constantly monitored through the interface, whether hard wired or wireless, using battery or other power.

In normal operation, between sleep periods, the controller will periodically apply power to the pressure transducer, read the output thereof and store that reading in the non-volatile memory at a frequency set by way of the personal computer or other device, usually only temporarily connected to the I/O. This accumulated data may be read at any time by such external device through the I/O as desired. In that regard, the I/O will typically be a bidirectional communication port, preferably a serial port, such as by way of example, a USB (universal serial bus) of other standard port, though other wired or wireless ports such as infrared or RF may be used as desired. If a wireless port is used, the device may be programmed to report in periodically, and/or whenever a problem (undesired pressure or low battery) occurs.

Also shown in FIG. 4 is a display that may be used to display the actual pressure and/or other information such as state of battery charge, rate of pressure change, etc. Such a display is optional, as the same information may be obtained through the I/O, though only when another device is connected thereto or at least communicating therewith. If used, the display may be a liquid crystal display, and by way of example, may be updated periodically, such as with the same period as the memory.

Pressure limits may be set through the I/O, typically with either a positive going or a negative going limit. In particular, normally for pressures above atmospheric, one is looking for a loss of pressure and thus a lower limit on pressure will be set. For pressures below atmospheric (vacuums), typically one is looking for a loss of the vacuum, and accordingly, an upper pressure limit (still typically below atmospheric) will be set. In that regard, preferably the pressure transducer can read both positive and negative gauge pressures for those applications where the same device may be used in applications where, from time to time, both increased and decreased pressures are to be monitored.

Finally, as may be seen in FIG. 4, a buzzer and LEDs are provided to indicate pressure status and battery status. In that regard, in the event the pressure being monitored drifts above or below the limit set, in this embodiment a red LED will be illuminated and the buzzer sounded. This may be on a continuous basis or on some predetermined intermittent basis, sufficiently frequently to provide the desired warning, though perhaps not continuous to preserve battery power, if battery power is used. At other times, a green LED may be continuously or intermittently illuminated to provide a visible indication that the unit is alive and well and that the pressure is within the desired limit. In that regard, as a matter of convenience, the green LED might be caused to flash each time the pressure transducer is powered up and a pressure reading is taken and recorded, thereby serving both to indicate that the unit is properly functioning and to further indicate that the frequency of data taken has been properly set. Also, in the case of a low battery, the state of the battery may be indicated by the buzzer and the LEDs, typically a red LED, by turning on the buzzer and the LED. In this case a different buzzer sound would be provided, preferably a sort of short period chirp and a short flash of the red LED, to indicate the low battery condition without using significant energy to do so.

While certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A pressure monitor comprising:
a self contained unit having a pressure sensor configured to be connected to an enclosed volume to be maintained at a pressure different from atmospheric pressure, an audible sound generator and an LED, the audible sound generator and the LED being responsive to the pressure sensor to emit an audible sound and a visible warning, respectively, when the pressure sensor senses pressure reaching a predetermined limit.

2. The monitor of claim 1 wherein the self contained unit includes a battery power supply.

3. The monitor of claim 2 wherein the pressure sensor comprises a pressure switch having a switching pressure adjustable by a manual control on the self contained unit.

4. The monitor of claim 1 wherein the pressure sensor comprises a pressure transducer.

5. The monitor of claim 4 wherein the self contained unit further comprises a controller with memory and an interface, the controller being responsive to inputs from the interface to periodically determine the output of the pressure transducer and to record that output in the memory, and to provide the recorded outputs through the interface when commanded to do so.

6. The monitor of claim 5 wherein the controller is responsive to inputs provided through the interface to set the predetermined limit of the pressure that will cause the emission of an audible sound and a visible warning.

7. The monitor of claim 6 wherein the controller is also responsive to inputs provided through the interface to determine whether pressures above or below the predetermined limit of the pressure will cause the emission of an audible sound and a visible warning.

8. The monitor of claim 5 wherein the controller is also responsive to inputs provided through the interface to set the frequency in which the controller determines the output of the pressure transducer.

9. The monitor of claim 5 wherein the controller causes the sound generator and the LED to emit an intermittent audible sound and an intermittent visible warning, respectively, when the pressure transducer senses pressure reaching a predetermined limit.

10. The monitor of claim 9 wherein the controller monitors a state of charge of the battery power supply, and when the state of charge is low, causes the sound generator and an LED to emit an intermittent audible sound and an intermittent visible warning, respectively, different from that emitted when the pressure transducer senses pressure reaching a predetermined limit.

11. The monitor of claim 5 wherein the interface is an interface for coupling to a personal computer.

12. The monitor of claim 11 wherein the interface is a wireless interface.

13. The monitor of claim 5 wherein the pressure transducer is off and the controller is in a sleep mode between periodic activations.

14. The monitor of claim 4 wherein the self contained unit further comprises a controller with memory and an interface, the controller continuously determining the output of the pressure transducer and providing the outputs through the interface.

15. A pressure monitor comprising:
a self contained unit having a pressure switch configured to be connected to an enclosed volume to be maintained at a pressure different from atmospheric pressure, an audible sound generator, an LED and a battery power supply, the audible sound generator and the LED being responsive to the pressure sensor to emit an audible sound and a visible warning, respectively, when the pressure sensor senses pressure reaching a predetermined limit, the self contained unit having an externally adjustable manual control for adjusting the predetermined limit.

16. A pressure monitor comprising:
a self contained unit having a pressure transducer configured to be connected to an enclosed volume to be maintained at a pressure different from atmospheric pressure, a controller and interface, an audible sound generator and an LED, the audible sound generator and the LED being responsive to the pressure sensor to emit an audible sound and a visible warning, respectively, when the pressure sensor senses pressure reaching a predetermined limit.

17. The monitor of claim 16 wherein the self contained unit includes a battery power supply.

18. The monitor of claim 17 wherein the controller is. Responsively to inputs from the interface to periodically determine the output of the pressure transducer and to record that output in the memory, and to provide the recorded outputs through the interface when commanded to do so.

19. The monitor of claim 18 wherein the controller is responsive to inputs provided through the interface to set the predetermined limit of the pressure that will cause the emission of an audible sound and a visible warning.

20. The monitor of claim 19 wherein the controller is also responsive to inputs provided through the interface to determine whether pressures above or below the predetermined limit of the pressure will cause the emission of an audible sound and a visible warning.

21. The monitor of claim 18 wherein the controller is also responsive to inputs provided through the interface to set the frequency in which the controller determines the output of the pressure transducer.

22. The monitor of claim 18 wherein the controller causes the sound generator and the LED to emit an intermittent audible sound and an intermittent visible warning, respectively, when the pressure transducer senses pressure reaching a predetermined limit.

23. The monitor of claim 22 wherein the controller monitors a state of charge of the battery power supply, and when the state of charge is low, causes the sound generator and an LED to emit an intermittent audible sound and an intermittent visible warning, respectively, different from that emitted when the pressure transducer senses pressure reaching a predetermined limit.

24. The monitor of claim 16 wherein the interface is an interface for coupling to a personal computer.

25. The monitor of claim 16 wherein the interface is a wireless interface.

26. The monitor of claim 16 wherein the pressure transducer is off and the controller is in a sleep mode between periodic activations.
